(19) United States
(12) Patent Application Publication
(10) Pub. No.: US 2016/0223087 A1
(43) Pub. Date: Aug. 4, 2016

(54) CONTROL VALVE SYSTEM FOR CONTROLLING FLUID FLOW

(71) Applicant: Sustainable Waste Power Systems, Inc., Kingston, NY (US)

(72) Inventors: Michael Joseph Gillespie, III, Shohola, PA (US); Christopher Paul Gillespie, Ridgefield, CT (US)

(21) Appl. No.: 14/617,491

(22) Filed: Feb. 9, 2015

Related U.S. Application Data
(60) Provisional application No. 62/111,323, filed on Feb. 3, 2015.

(51) Int. Cl. F16K 1/00; F16K 31/12; F16K 31/02

(52) U.S. Cl. CPC F16K 1/00; F16K 31/02; F16K 31/12

(57) ABSTRACT

This disclosure relates to a system and method for controlling a carbonaceous feedstock into a devolatilization reactor. The system includes a control valve system for modulating slurry. The control valve system includes a valve, an actuator, and a position controller. The valve includes a flow restrictor and a seat. The valve may be configured to control the flow of the slurry, wherein when the flow restrictor is engaged with the seat, the valve is in a close position, and when the flow restrictor is not engaged with the seat, the valve is in an open position. The actuator may be configured to control opening and closing of the valve. The actuator may be coupled to the position controller. The position controller may be configured to determine the position of the actuator. The seat may be configured to support the flow restrictor.

CROSS-REFERENCE

This application claims the benefit under 35 U.S.C. §119(e) of Provisional U.S. Patent Application No. 62/111,323 filed on Feb. 3, 2015, and entitled “CONTROL VALVE SYSTEM FOR CONTROLLING FLUID FLOW,” the content of which is incorporated by reference herein in its entirety.

### TECHNICAL FIELD

This disclosure relates generally to machines that devolatilize materials, and more particularly, to a control valve system for controlling the flow of a feedstock material through a devolatilization system.

### BACKGROUND

Control valves are used to control the flow of feedstock material through a variety of devices, including devolatilization reactors, gasifiers, and other slurry piping systems utilized for slurry transport, treatment, and/or processing. Control valves are coupled to the entrance and/or exit of these devices and are used to control the flow rate of the feedstock.

Current methods for controlling the flow of feedstock material into a device include using traditional valves. These valves may include pinch valves, swing check valves, gate valves, ball globe valves, or other commercially available valves, configured to allow and restrict the flow of a fluid.

Hydraulic control valves are traditionally utilized to modulate or actuate fluids including air, gas, oil, water, and the like. These valves are for high pressure, clean fluid systems, and may include strong billet stainless steel bodies and heavy duty seats. However, using hydraulic control valves to control feedstock slurry has not been considered for concern over damage and/or wear to the valve. Feedstock may contain a liquid and solid combination which can cause an inconsistent flow of the feedstock through the valve causing unintended disruptions.

Thus, an improved system for controlling the flow of a feedstock material into a devolatilization reactor is desired to increase efficiencies.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

One embodiment of the present disclosure includes a control valve for modulating a slurry. The control valve includes a valve body, a pin, and an actuator. The valve body defines a flow channel. The flow channel has a channel diameter configured to allow slurry to flow through the valve body. The flow channel is further configured to accept slurry from an intake device. The intake device has an intake diameter such that the channel diameter and the intake diameter are substantially the same. The pin is moveably coupled to the valve body. The pin is configured to slide into any position within the flow channel between a first position and a second position. In the first position the flow of slurry through the flow channel is restricted. In the second position the flow of slurry is allowed through the flow channel unrestricted up to a maximum channel diameter. The actuator is configured to move the pin from the first position to the second position in rapid succession.

Another embodiment of the present disclosure includes a flow control system for controlling the flow rate of slurry through a device. The device has an entrance and an exit and a device channel that extends from the entrance to the exit and has a first diameter. The flow control system includes a pump and a control valve. The pump is fluidly coupled to the entrance of the device and configured to pump the slurry into the device. The control valve is fluidly coupled to the exit of the device and includes a valve body, a pin, and an actuator. The valve body defines a flow channel that has a second diameter configured to allow slurry to flow through the valve body. The flow channel is further configured to accept slurry from the device. The first diameter and the second diameter are substantially the same. The pin is moveably coupled to the valve body and configured to slide into any position within the flow channel between a first position and a second position. In the first position the flow of slurry through the flow channel is restricted and in the second position the flow of slurry is allowed through the flow channel unrestricted up to a maximum second diameter. The actuator is configured to move the pin from the first position to the second position in rapid succession.

Another embodiment of the present disclosure includes a method for controlling the flow of slurry, by a control valve, through a device. The control valve includes a seat and a pin. The method includes admitting the slurry into the control valve. The control valve has a valve body defining a flow channel having a first diameter configured to allow slurry to flow through the valve body. The flow channel is further configured to accept slurry from the device. The device has a second diameter, such that the first diameter and the second diameter are substantially the same. The method further includes controlling, by the pin, a pressure of the slurry through the device. An actuator is configured to control the pin to a first position from a second position and from the second position to the first position. The slurry passes through the valve body upon exiting the device.

### BRIEF DESCRIPTION OF THE DRAWINGS

FIG. 1 is a schematic of a devolatilization system, according to one aspect of the disclosure.

FIG. 2 is a side view of a control valve system, according to one aspect of the disclosure.

FIG. 3 is a cross-sectional view of the front of an embodiment of a control valve system with a pin in a closed position, according to one aspect of the disclosure.

FIG. 4 is a cross-sectional view of the front of an embodiment of a control valve system with a pin in an open position, according to one aspect of the disclosure.

FIG. 5 is a cross-sectional view of the front of another embodiment of a control valve system with a pin in an open position, according to another aspect of the disclosure.

FIG. 6 is a schematic of a controller used to control a devolatilization system, according to one aspect of the disclosure.

FIG. 7 is a pin position diagram during operations, according to an aspect of this disclosure.

FIG. 8 is a pin position diagram during a valve clear operation, according to an aspect of this disclosure.

FIG. 9 is a cross-sectional view of a portion of the front of another embodiment of a control valve system having debris within, according to an aspect of this disclosure.

### DETAILED DESCRIPTION OF ILLUSTRATIVE EMBODIMENTS

The disclosure relates generally to a system and method for controlling the flow of carbonaceous feedstock through a devolatilization reactor. The method includes providing the feedstock to a devolatilization system, whereby the feedstock is heated and substantially pulverized. While the feedstock is being heated, the materials composing the feedstock, including entrained volatiles, are thermally converted into simple carbon constituents that may be used as synthetic natural gas after separation from the water and remaining devolatilized solid fraction, or be used in a gasification reactor to further convert the devolatilized solids and volatiles together into a product SynGas.

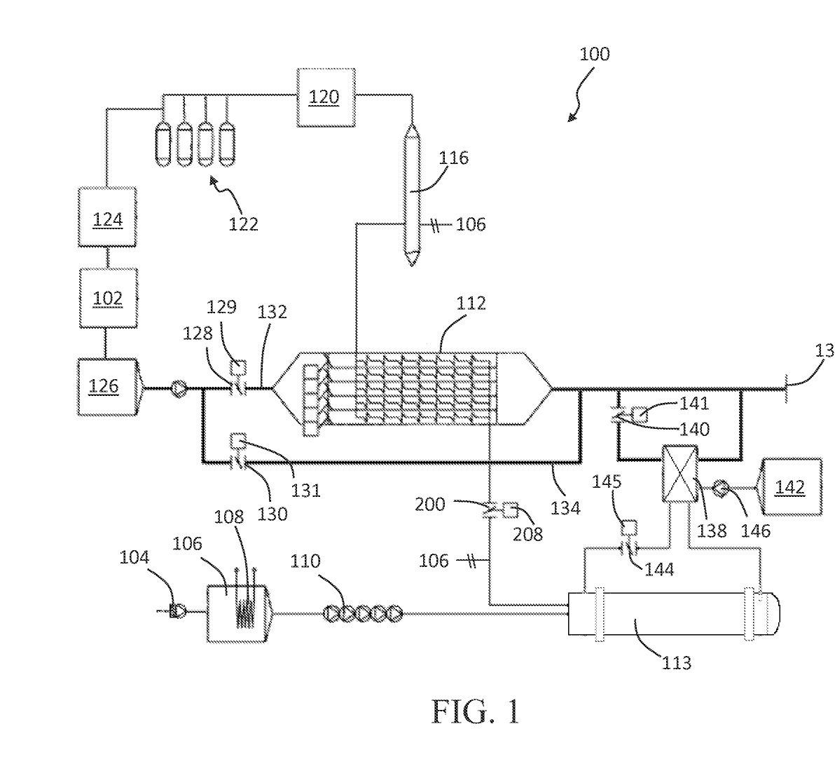

As used herein, the term “feedstock” generally means any energy-bearing material that may be fed into a system for processing purposes. Feedstock may be in the form of municipal garbage and sewage and may include farm waste, food processing waste, etc. Feedstock can be sourced from any number of carbon-based materials. It should be appreciated that the output of one system may serve as the feedstock input material for another system, such as a gasifier 112 as illustrated in FIG. 1. Further, the devolatilization method may process any type of carbonaceous feedstock, utilizing similarly physically designed devolatilization systems for any given feedstock. The systems may be modular and may be tuned in terms of capacity and reaction parameters.

FIG. 1 is a schematic of an embodiment of a power plant system 100 (“power plant”) which comprises a control valve system 200 for controlling the flow of feedstock through a reactor 113. The power plant 100 may utilize fuel cells as the primary energy generator 102. The power plant 100 may provide both power generation and waste disposal. In other embodiments, the power plant 100 may produce district natural gas and utilize the gas for mechanical power generation for use in a third party process. It should be appreciated that the power plant 100 may be arranged in a variety of configurations.

The acceptance of feedstock may enter in through grinders 104, and deposited in one or more holding tanks 106. The holding tank 106 may include tank heating coils 108, for preheating the feedstock prior to entering the devolatilization reactor 113. Feedstock may also include dedicated waste handling systems such as farm waste, food processing waste, etc. Feedstock can be sourced from any number of carbon-based materials. The power plant 100 may be configured to accept any combination of these feedstock streams.

It should be appreciated that there may be more than one grinder 104, and that the feedstock may flow through a series of grinders and pumps which grind the feedstock to a variety of dimensions. These may include fine grinder pumps, secondary grinder pumps, and other similar mechanisms. The feedstock may be ground to sizes as small as 0.005 inches or as large as 6 inches. This ground form of feedstock may be referred to as “feedstock slurry.” Additionally, there may be more than one holding tank 106, whereby feedstock having varying properties may be stored separately.

After the feedstock is ground, the resulting slurry is stored in the one or more storage tanks 106. A pressure pump 110 may be used to pump the slurry into the devolatilization reactor 113. The flow of feedstock may be controlled by the control valve 200 by providing back-pressure to the reactor 113. The slurry is at a high pressure when delivered from the pump 110. In an embodiment, the pressure may be between 500 and 900 psia as it enters the devolatilization reactor 113. It should be appreciated that the pressure at which the devolatilization reactor 113 operates is such that the water in the slurry may flash to steam as it flows through the control valve 200. In an embodiment, the feedstock may comprise between 40% and 85% water.

The devolatilization reactor 113 may provide a first stage of feedstock thermal treatment. The feedstock may be treated at high pressure, between 300 and 900 psia, and medium temperature, between 300 and 600 degrees F. The reactor 113 may also treat the feedstock at temperatures between 400 and 500 degrees F., at a pressure just above the treatment temperature's steam saturation pressure. The feedstock may have a long residency time within the reactor 113, where the elevated temperatures and high pressure basically cook the material which releases simple gaseous constituents having simple hydrocarbons and other gaseous compounds and elements in a process known as devolatilization. Devolatilization entails the release of volatile constituents of the feedstock such as oxygen, and lighter and more easily released simple hydrocarbons.

In the illustrated embodiment, the feedstock slurry is pumped from the holding tanks 106 and into the devolatilization reactor 113. After the feedstock leaves the reactor 113, the feedstock slurry may be substantially converted to char slurry. Char includes more complex carbon based constituents in solid or liquid form substantially devoid of volatile materials that requires further processing to break down the final carbon bonds and produce synthetic natural gas. The feedstock may then flow through the control valve 200 and enter into a gasifier 112. It may also be returned to the holding tanks 106 along a feedstock recycle line, whereby it is recycled and further treated. Steam may be admitted to the feedstock from a steam header (not shown), prior to entering the gasifier 112.

The gasifier 112 performs a gasification process on the feedstock slurry. As the feedstock passes through the control valve 200, a portion of the water within the slurry will flash to steam. As it flashes, it becomes both a pulverizing force and a motive fluidizing agent which carries the feedstock through the gasifier 112. The steam is also a significant heat transfer medium between the feedstock and the gasifier heating medium. It is also a hydrogenating fluid, as the temperature at which the gasification occurs is within the region where the water-gas shift occurs.

Upon exit, the feedstock enters into a separator 116. The separator 116 may be of standard construction known in the field, and may feature a water bath at the base, where particulates such as ash are collected. The ash may be handled by an ash handling system (not shown). An ash handling system may include slurry pumps, separation tanks, grinder pumps, recycle circuits, transport circuits, and other components known in the art. The ash may be recycled along a recycle line and returned to the holding tanks 106 or it may be transported, for example, by a truck to a material recycler. It should be appreciated that in an alternative embodiment, that the power plant 100 may not include a gasifier and the devolatilization process ends after the feedstock exits the reactor 113.

In the separator 116, the thermally converted synthetic natural gas is separated from any entrained ash or slag that is unwanted. To further separate the fine particles, the gas may exit the separator 116 and pass through a screen filter (not shown) and an aftercooler 120. The gas may be cooled and the condensate from the steam may be drained. The filters and aftercooler 120 may be of standard construction as known in the field.

The synthetic natural gas may leave the aftercooler and be routed to gas storage tanks 122, an auxiliary boiler 124, the primary energy generator 102, or combinations thereof. The gas may also be routed to other applications that may require natural gas, such as a booster heater.

The primary energy generator 102 may be a molten carbonate fuel cell (MCFC), a reciprocating engine, gas turbine, boiler, or other commercially available energy generation source. The primary energy generator 102 converts the natural gas into electricity and also produces heat to drive the remainder of this process. The heat produced by the energy generator 102 may be provided to the gasifier heating medium or fluid stored in a gasifier heating medium storage tank 126. In alternate embodiments, the gasifier heating fluid may be heated using coils prior to entering the storage tank 126, by burners upon exiting the storage tank 126, or combinations thereof.

The gasifier heating fluid may be pumped into the gasifier 112 through a gasifier heating fluid control valve 128 along a main path 132 and/or pumped along a bypass 134 through a bypass control valve 130. The bypass 134 rejoins the main path 132 after the gasifier heating fluid flows through the gasifier 112, whereby the heating fluid is exhausted 136 from the system 100. The heating fluid may also be diverted to a reactor heating medium generator 138, through a coil control valve 140, which is used to provide heat to a reactor heating medium used to provide heat to the devolatilization reactor 113. The reactor heating medium may be stored in a storage tank 142. The reactor heating medium may be pumped into the reactor 113 by a pressure pump 146 and may be regulated by a reactor heating fluid control valve 144. In alternate embodiments, prior to the heating fluid being exhausted, it may be admitted to a heat recovery steam generator, hot water generator, or other heat recovery apparatus known in the art. The reactor heating medium is preferably a heating oil, which has been previously heated by any one or combination of sources.

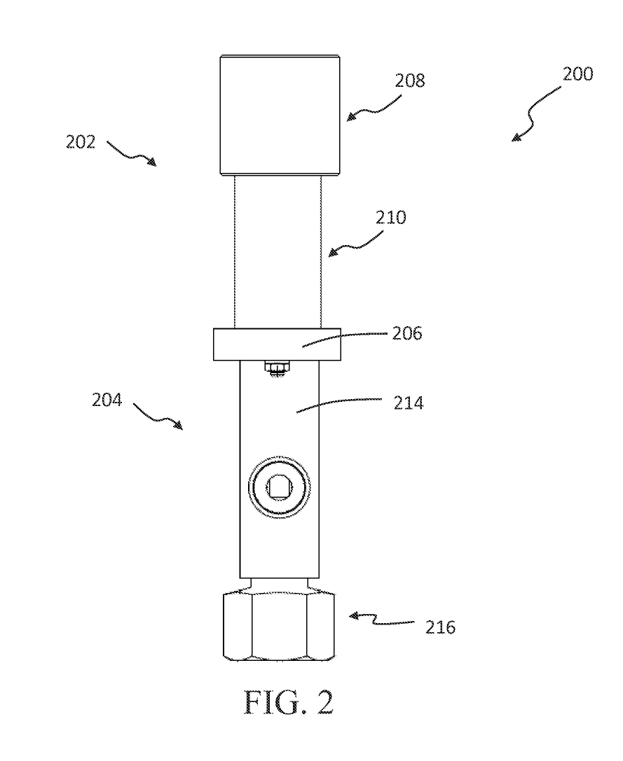

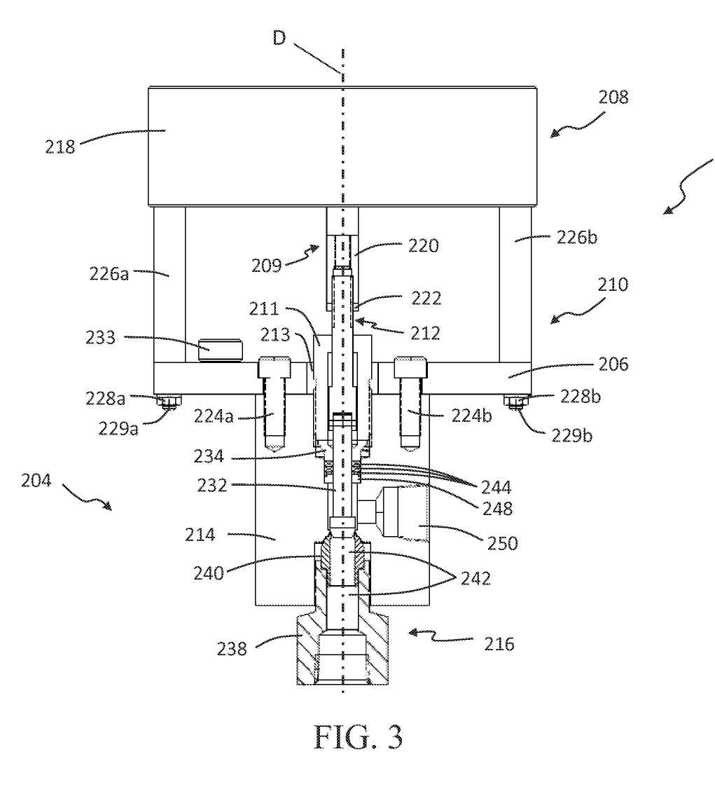

FIGS. 2 and 3 illustrate a side view and cross sectional front view of an embodiment of the control valve system 200, respectively. The valve system 200 includes a top portion 202, a body portion 204, and a base plate 206. The top portion 202 includes an actuator 208 and a spacer assembly 210. The body portion 204 includes a main body 214 and an adapter assembly 216. The control valve system 200 is configured to control or modulate the flow of slurry there through. In an embodiment, the control valve system 200 may include a hydraulics control valve.

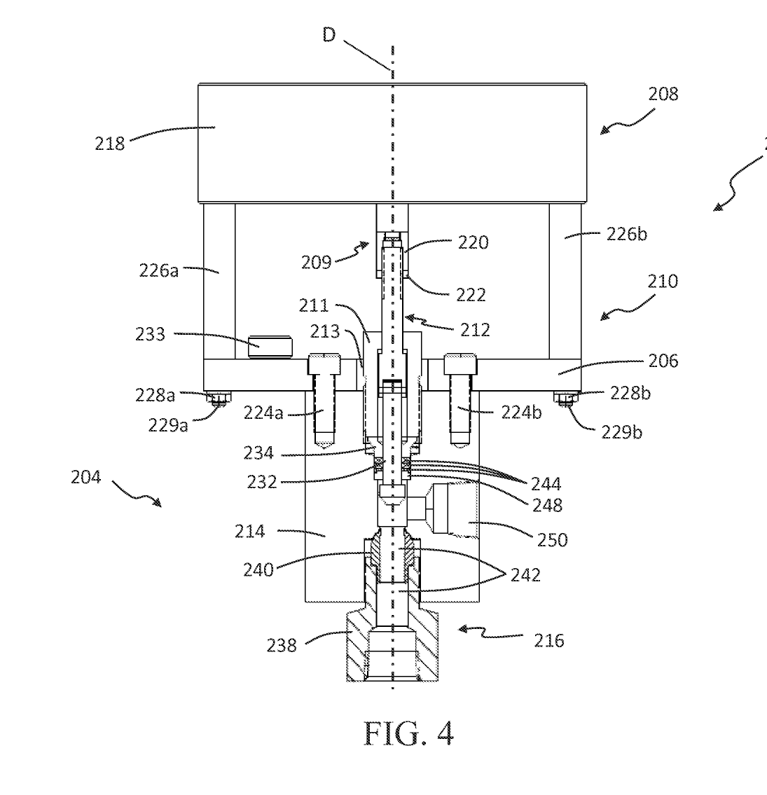

FIGS. 3 and 4 illustrate a cross-sectional view of the front of the control valve system 200 in a close position and an open position, respectively. The actuator 208 includes an operator assembly 218 and a coupling assembly 209 operatively connected to the operator assembly 218. The coupling assembly 209 includes a coupling 220 and a jam nut 222 for connecting the actuator 208 to the main body 204. It should be appreciated that a threaded coupling nut set may be used to connect the actuator 208 to the main body 204. The actuator 208 is configured to drive the coupling assembly 209 in a reciprocating motion along an axis D. The actuator 208 may include a hydraulic actuator, a pneumatic actuator, an electrically driven actuator, or other actuator configured to drive a coupling assembly 209. The axis D is defined as the central vertical axis of the control valve system 200, and extends from the top portion 202 through the main body portion 204. As used herein, the “top end” or “bottom end” of a component refers to the end of a component that is closer to the actuator 208 or closer to the adapter assembly 216, respectively.

The actuator 208 may be operatively connected to an upper stem assembly 212, whereby the coupling 220 is connected to the top end (not labeled) of the upper stem assembly 212. The upper stem assembly 212 may be positioned within the coupling 220 and held into place by a jam nut 222. The connection may be such that the reciprocating motion of the coupling assembly 209 may cause a reciprocating motion of the upper stem assembly 212 along the D axis. The upper stem assembly 212 extends from actuator 208 through a packing gland 211, and into the main body 214. A flow restrictor 332, illustrated in one embodiment as a pin, is coupled onto the bottom end (not labeled) of the upper stem assembly 212. The flow restrictor 232 may be any structure, such as a plate, disc, dowel, or the like, that can restrict the flow of a fluid. It should be appreciated that the upper stem assembly 212 may be coupled to the pin 232 using a pin connection, welding, or combinations thereof, or other coupling means as known in the art. The coupling between the upper stem assembly 212 and the pin 232 is such that the reciprocating motion of the stem assembly 212 causes a reciprocating motion of the pin 232 from a closed position (FIG. 3) to an open position (FIG. 4), along axis D. The pin 232 may be an unbalanced needle design.

The packing gland 211 may be threadedly attached to the main body 214. The outside surface (not labeled) of the gland 211 may engage with an internal surface (not labeled) of the main body 214. In other embodiments, the packing gland 211 may be attached by other means commonly used in the art. The packing gland 211 may define an inner portion configured to allow the upper stem assembly 212 to slidably move within, allowing the upper assembly 212 to move in a reciprocating motion along axis D. The packing gland 211 is also configured to fit within a hole 213 defined by the base plate 206.

The base plate 206 is coupled to the main body 214 by mounting screws 224a and 224b. The mounting screws 224a and 224b may fit within predefined holes (not labeled) in the base plate 206 and threadedly engage the main body 214. The plate 206 further defines the hole 213 which the gland 211 may fit within. The actuator 208 is coupled to the bracket 206 by the spacer assembly 210. The spacer assembly 210 includes spacers 226a and 226b, jam nuts 228a and 228b, and connecting rods 229a and 229b. The connecting rods 229a and 229b are attached to the base plate 206 by the jam nuts 228a and 228b, respectively. The jam nuts 228a and 228b secure the spacers 226a and 226b between the actuator 208 and the base plate 206. The length of spacer 226a, extending from its top most end to its bottom most end, is substantially the same length as spacer 226b. It should be appreciated that the length of each spacer 226a and 226b is configured to allow the upper stem assembly 212 and the coupling 220 to move along the D axis.

In an alternative embodiment, the spacer assembly 210 may be directly connected to the packing gland 211. In this embodiment, the spacer assembly 210 may be supported by the base plate 206, and locked into place by a locking nut.

The adapter assembly 216 includes an adapter opening device 238 and a seat 240. The adapter opening device 238 may be threadedly engaged with an interior surface (not labeled) of the main body 214. The adapter assembly 216 is positioned at the bottom most end (not labeled) of the main body 214. In an embodiment, the adapter assembly 216 may be positioned at different locations on the main body 214. The opening device 238 is configured to support the seat 240 within the main body 214, such that when the opening device 238 is threadedly engaged, the seat 240 is supported within the main body 214. The opening device 238 and the seat 240 are further configured to define a portion of a flow channel 242. It should be appreciated that the seat 240 may be a replaceable seat.

The seat 240 is further configured to support the pin 232 within the main body 214. The pin 232 may be lowered onto the seat 240 by the actuator 208 and the upper stem assembly 212. When the pin 232 is in its lowest vertical position along the D axis (FIG. 3) and in contact with the seat 240, the control valve system 200 is in a closed position. When the pin 232 is not in its lowest vertical position then the control valve system 200 is in an open position. FIG. 4 illustrates the pin 232 in an open position. In an embodiment, the pin 232 and the seat 240 may be made of a high-strength alloy, including, but not limited to, steel, aluminum, or titanium alloys.

The body portion 204 may also include packing elements 244, a packing washer 234, and a bottom washer 248 attached to an interior surface (not labeled) of the main body 214. These elements may be used, for example, to support the gland 211, align the pin 232, and to prevent the flow of slurry into the top portion 202 of the control valve system 200.

The main body 214 may also define a flow port 250 and a portion of the flow channel 242. The flow port 250 may fluidly connect to channel 242, thereby composing a slurry flow channel through the control valve system 200. When the control valve system 200 is in the open position, slurry may flow through the channel 242 and the flow port 250.

The interior surfaces (not labeled), the flow port 250, and the portion of the channel 242 which the main body 214 defines, all compose a main body 214 chamber. The main body 214 chamber may include a variety of configurations or orientations which allow the flow and control of feedstock through the control valve system 200.

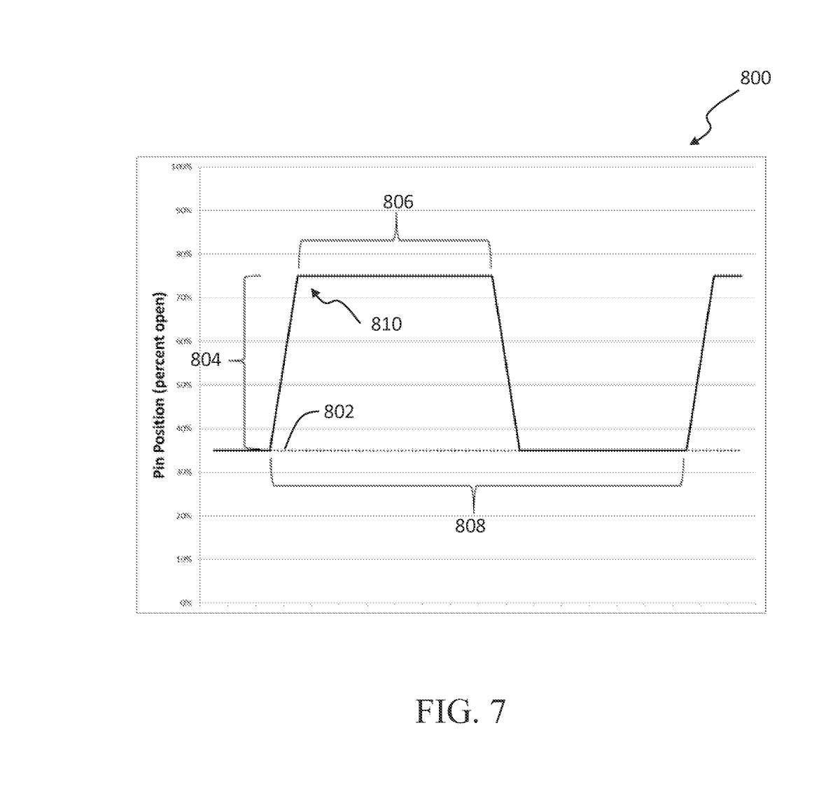

The actuator 208 may be configured to actuate the control valve system 200 between the open position and the closed position. Input to the actuator 208 may be received from an operator via controller 700 (FIG. 7) our automatically controller 700 (FIG. 7) based on a predetermined condition. During a devolatilization process, whereby feedstock is pumped, by the main pump 110, into the reactor 113, the feedstock exits the reactor 113 and flows through the control system 200. In an embodiment, when the flow restrictor or pin 232 is in an open position, the feedstock may enter through the adapter opening device 238, and flow through the seat 240 within the flow channel 242. The fluid flows past the pin 232 and exits the system 200 through the flow port 250, whereby it enters into the gasifier 112. When the when the flow restrictor or pin 232 is in a closed position, the pin 232 is engaged with the seat 240, thereby restricting the flow of the feedstock through the seat 240, and therefore, restricting the flow through the channel 242.

Over time, the feedstock flowing through the control valve system 200 may cause the pin 232 and the seat 240 to wear. The feedstock generally comprises a solid and fluid mixture, and when it is controlled through the system 200 it comes in direct contact with the pin 232 and the seat 240. As this wear occurs, the travel distance of the pin 232 to engage the seat 240 may increase, requiring additional motion of the actuator 208 to control the valve system 200 from the open position to the close position.

A position controller 233 may be configured to determine the status or condition of the actuator 208. The position controller 233 may also be configured to determine the travel range of the flow restrictor 232 from the open position to the close position. The travel range may be utilized in order to determine the integrity of the pin 232 and the seat 240. Accordingly, the position controller 233 may provide an indication of when the wear exceeds a certain threshold, thereby indicating that the pin 232 and/or seat 240 may need to be replaced. It should be appreciated that a 100% shutoff (for example, such as, when the pin 232 in the closed position) may not be required for the valve system 200 to operate effectively. The indicator, along with the determined position of the actuator 208, may be provided to valve system 200 operators, power plant 100 operators, the controller 700, and/or any other necessary control means. The position controller 233 is coupled to the base plate 206. However, it should be appreciated that the controller 233 may be located remotely or coupled to another portion of the valve system 200.

The control valve system 200 may also include a locking mechanism (not shown) coupled to the main body 214 for restricting the motion of the packing gland 211 during valve 200 operations. The locking mechanism may include a locking nut and a locking screw. The locking nut may be configured to allow the locking screw to fit within and may be threadedly engaged with the screw. An outside surface of the locking nut may be configured to contact the packing gland 211. The contact between the locking nut and the gland 211 may lock the gland 211 onto the main body 214. The locking screw may also threadedly engage with an interior surface of the main body 214, coupling both the screw and the nut to the main body 214.

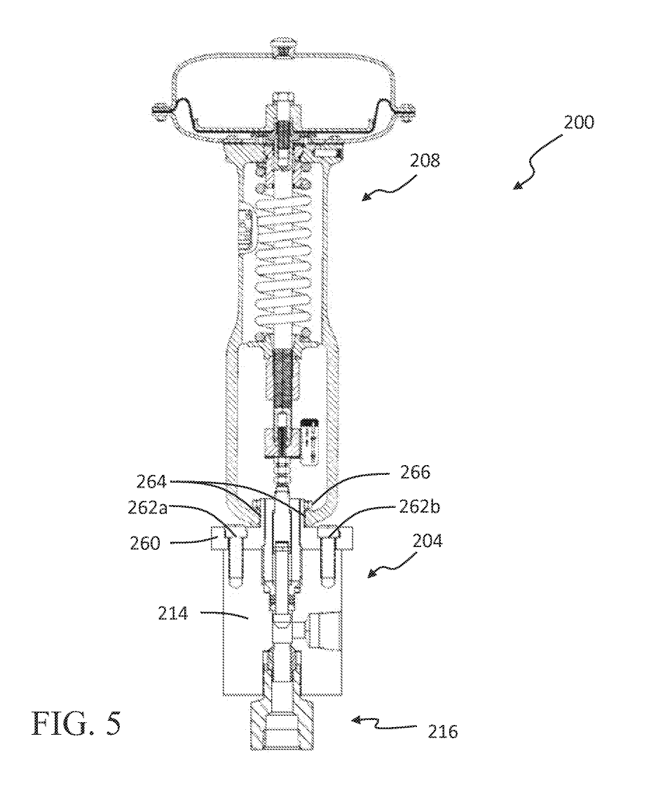

FIG. 5 illustrates an alternative embodiment for a valve system 200. The actuator 208 may be operatively connected to the body portion 204 by using a mounting bracket 260. The mounting bracket 260 may be connected to the body porition 204 by using multiple mounting screws 262a and 262b. The mounting screws 262a and 262b may fit within predefined holes (not labeled) in the mounting bracket 260 and threadedly engage the main body 214. It should be appreciated that the mounting bracket 260 may be connected to the main body 214 in various ways including welding, adhesives, or other means commonly used in the art.

The actuator 208 may be connected to the mounting bracket 260 via a threaded connection 264. The actuator 208 and the mounting bracket 260 may each include a threaded portion (not labelled) that interconnects at the threaded connection 264. The actuator 208 may be held in place on the mounting bracket 260 by a locking nut 266. The locking nut 266 may include a threaded portion (not labelled) configured to interconnect with the threaded portion of the mounting bracket 260. It should be appreciated that the actuator 208 may be operatively connected to the body portion 204 of the valve system 200 by alternate means, and that this description is merely an illustrative example of an attachment means for the actuator 208.

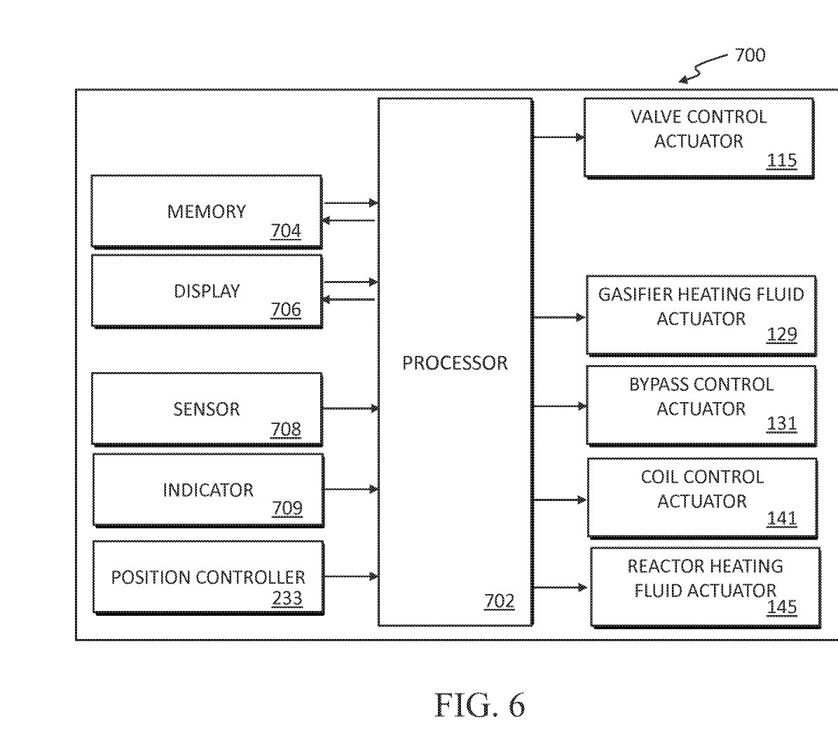

FIG. 6 illustrates the controller 700 which may be included in the power plant 100. The controller 700 may be an electronic control unit, which may be used to facilitate control and coordination of any methods or procedures described herein. As illustrated in FIG. 6, the controller 700 may include a processor 702, memory 704, display 706, the position controller 233, and valve actuators. The processor 702 may be configured to output signals to valve actuators and/or receive values sensed by sensors or gauges 708, such as temperature and pressure. The processor may be further configured to output signals that indicate failures that have been determined by indicators 709. The output signals and sensed values may be stored in memory, shown on a display 706, and used by the controller 700 to control the flow of the feedstock through the power plant 100. In the illustrated embodiment, the actuators include the control valve actuator 208, a gasifier heating fluid actuator 129, a bypass control actuator 131, a coil control actuator 141, and a reactor heating fluid actuator 145 coupled to the control valve system 200, gasifier heating fluid control valve 128, bypass valve 130, coil control valve 140, and reactor heating fluid control valve 144, respectively. It should be appreciated that in other embodiments, additional actuators, sensors, or gauges may be used, for example, to sense and control the pressure and temperature of the feedstock within the reactor 113 and the gasifier 112. Additionally, sensors or gauges may be used to sense and control the pressure and temperature of the gasifier heating fluid flowing through the gasifier 112 and the reactor heating fluid flowing through the reactor 113. While the controller 700 is represented as a single unit, in other aspects the controller 700 may be distributed as a plurality of distinct but interoperating units, incorporated into another component, or located at different locations on or off the power plant system 100.

FIG. 7 illustrates a pin position diagram 800 of the pin 232 within the control valve system 200 during operations. The control valve system 200 may include four distinct operations, including, valve system start-up, valve system operation, valve system clear, and valve system shutdown. The position of the pin 232 within the valve system 200 and the behavior may be set by the controller 700 by setting a percent open or closed between 0 percent and 100 percent. A first position, which may be the close position, may be set to 0 percent and a second position, which may be the open position, may be set to 100 percent. The controller 700 may move the pin 232 to any position between 0 percent and 100 percent.

Upon system start up, the controller 700 may command the control valve actuator 208 to force the pin 232 into the first position, or close position. The pin 232 may remain in that position as the controller 700 brings the system 200 up to an operating temperature and pumps fluid into the reactor 113 until a preset pressure point is reached within the reactor 113. In an embodiment, the operating temperature may be between 500 and 600 degrees Fahrenheit. The preset pressure may be based on the saturation pressure of water at the present operating temperatures. Upon reaching the preset pressure point, the controller 700 may command the valve system 200 to begin system operation.

The valve system operation behavior may be described as an oscillation of the pin 232 within the valve system 200 anywhere between the first and second positions. The position of the pin 232 during this oscillation may be controlled by a number of variables. The variable can include the set point 802, the amplitude 804, the duration 806, and the period of oscillation 808.

The set point 802 is an initial position of the pin 232 and may be set by a default value upon initialization or changed to any value by the controller 700. In an embodiment, the controller 700 may receive temperature data from a sensor (not shown) monitoring the temperature of the process gas out of the gasifier 112, and based on this temperature data, the controller 700 may change the set point 802. If the process gas has a low temperature, the controller 700 may change the set point 802 to be higher to allow more material to flow into the gasifier 112. If the process gas has a high temperature, the controller 700 may change the set point 802 to be lower to allow less material to flow into the gasifier 112. It should be appreciated that the process gas may include the synthetic gas and an ash mixture exiting the gasifier 112 and steam.

The amplitude 804 is the magnitude of the increase in a percent opening of the pin 232 during valve system operation. The pin 232 oscillates between the set point 802 and the maximum position 810 (set point 802 plus the amplitude 804). The maximum position 810 may be set by a default or changed by the controller 700 to maintain pressure and flow stability within the reactor 113.

The duration 806 is the amount of time the pin 232 may remain in the maximum position 810. Upon the expiration of this time frame, the pin 232 may drop back to the last set point 802. The duration 806 may be set by default or changed by the controller 700 to maintain pressure stability in the reactor 113.

The period of oscillation 808 is the length of time of the oscillation pattern. At the expiration of this time frame, the controller 700 may begin the next oscillation. The period 808 may be set by default upon initialization or changed by the controller 700 to maintain pressure stability in the reactor 113.

The oscillation pattern may continue throughout the valve system operation as the set point 802 is changed up or down in percentage as the feedstock characteristics change and impact the quality and quantity of a synthesis fuel being produced. The quantity and quality of the synthesis fuel being produced may be determined by the temperature and pressure of the gas after exiting the gasifier 112 and prior to entering the aftercooler 116.

The valve system operation may continue until one or more of number conditions are encountered. These conditions may include over pressure in the reactor 113, a pressure spike in the reactor 113 (such as for example a rapid increase in pressure of the feedstock), or a system shutdown. If an over pressure or a pressure spike condition occurs, then a system clear response may be triggered.

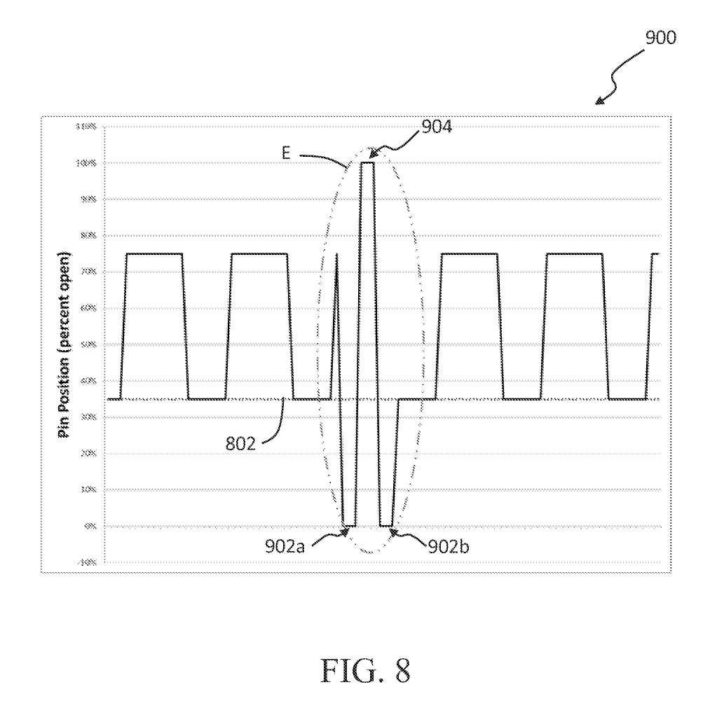

FIG. 8 illustrates a pin position diagram 900 of the pin 232 within the control valve system 200 during a valve system clear E, according to an aspect of this disclosure. During the valve system clear E, the controller 700 may command the pin 232 into the first position 902a, then the controller 700 may command the pin 232 into the second position 904, then the controller may command the pin 232 back into the first position 902b before returning the pin 232 to the last set point 802. Upon the completion of this response, the controller 700 may either return the valve system 200 to valve system operation or repeat the valve system clear E until the over pressure or pressure spike condition is eliminated.

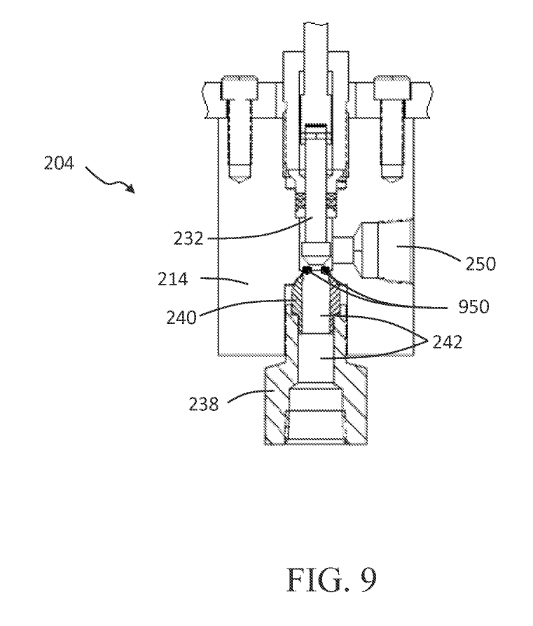

The movement of the pin 232 between the first positions (902a and 902b) and the second position 904 may be performed in rapid succession. This may provide for the ability to clear the main body 214 chamber and flow channel 242. FIG. 9 illustrates the body portion 204 of the valve system 200 having debris 950 in the main body 214 chamber. While feedstock is being admitted and restricted from entering the valve system 200, feedstock may build up inside the chamber within the main body 214. Rapidly opening and closing the control valve 200 may remove unnecessary feedstock, allowing the control valve 200 to continue to operate effectively. As referred to herein, moving the pin 232 in “rapid succession” may be defined as moving the pin from an open position to a close position and back to an open position within a tenth of a second.

A final operation of the valve system 200 is the system shutdown. The system shutdown may flush the valve system 200 of any feedstock as well as cool down the system 200 below a flash point of the fluid in the feedstock.

While the disclosure is described herein using a limited number of embodiments, these specific embodiments are not intended to limit the scope of the disclosure as otherwise described and claimed herein. Modification and variations from the described embodiments exist. More specifically, the following examples are given as a specific illustration of embodiments of the claimed disclosure. It should be understood that the invention is not limited to the specific details set forth in the examples.

What is claimed:

1. A control valve configured to control the flow of slurry, the control valve comprising:
a valve body defining a flow channel having a channel dimension, the flow channel configured to allow slurry to flow through the valve body, the flow channel further configured to accept slurry from an intake device, the intake device defining an intake device dimension that is no greater than the channel dimension;
a flow restrictor moveably coupled to the valve body, the flow restrictor configured to be actuated between a first position and a second position at least partially in the flow channel, wherein in the first position the flow of slurry through the flow channel is restricted, and in the second position the flow of slurry is allowed through the flow channel unrestricted; and
an actuator configured to actuate the flow restrictor between the first position and the second position.

2. The control valve of claim 1, further comprising a position controller coupled to the actuator, wherein the position controller is configured to determine the position of the actuator.

3. The control valve of claim 1, wherein the actuator is selected from a group consisting of a hydraulically driven actuator, a pneumatically driven actuator, and an electrically driven actuator.

4. The control valve of claim 1, further comprising a mounting bracket coupled to the control valve system, and configured to allow the actuator and the position controller to be supported thereon.

5. The control valve of claim 1, wherein the slurry comprises between 40% and 85% water.

6. The control valve of claim 5, wherein the valve body is configured such that at least a portion of the water flashes to steam as it flows through the valve body.

7. The control valve of claim 2, wherein the valve further comprises a seat configured to support the flow restrictor, wherein when the flow restrictor is in the first position the flow restrictor is engaged with the seat.

8. The control valve of claim 7, wherein the flow restrictor and seat are made of a high-strength alloy.

9. The control valve of claim 7, wherein the position controller is further configured to measure a travel range of the flow restrictor within the flow channel, wherein the integrity of the seat and the flow restrictor is determined based on the travel range.

10. The control valve of claim 1, wherein the flow restrictor is further configured to control the pressure drop of the slurry through the valve body.

11. The control valve of claim 1, wherein the flow restrictor is an unbalanced pin, and wherein the actuator is sized such that a force imparted on the flow restrictor by the actuator is enough to move the flow restrictor between the first position and the second position against an inlet pressure.

12. The control valve of claim 1, wherein the actuator is further configured to move the flow restrictor from the first position to the second position and from the second position to the first position such that any obstruction in the flow channel is substantially removed.

13. The control valve of claim 1, wherein the actuator is further configured to actuate the flow restrictor between the first position and the second position in rapid succession.

14. A flow control system for controlling the flow rate of slurry through a device, wherein the device has an entrance and an exit and a device channel that extends from the entrance to the exit, wherein the device channel has a device dimension, the control valve system comprising:
a pump fluidly coupled to the entrance of the device and configured to pump the slurry into the device; and
a control valve fluidly coupled to the exit of the device, the control valve comprising:
a valve body defining a flow channel having a channel dimension, the flow channel configured to allow slurry to flow through the valve body, the flow channel further configured to accept slurry from the device, wherein the device dimension is no greater than the channel dimension;
a flow restrictor moveably coupled to the valve body, wherein the flow restrictor is configured to move at least partially in the flow channel between a first position and a second position, wherein in the first position the flow of slurry through the flow channel is restricted, and in the second position the flow of slurry is allowed through the flow channel unrestricted; and
an actuator configured to move the flow restrictor between the first position and the second position.

15. The flow control system of claim 14, wherein the flow rate of the feedstock is controlled by a back pressure imparted on the slurry by the control valve.

16. The flow control system of claim 14, wherein the device is a devolatilization reactor.

17. A method for controlling the flow of slurry by a control valve through a device, wherein the control valve comprises a seat and a flow restrictor, the method comprising:
admitting the slurry into the control valve, wherein the control valve has a valve body defining a flow channel having a channel dimension, the flow channel configured to allow slurry to flow through the valve body, the flow channel further configured to accept slurry from the device, the device defining a device dimension that is no greater than the channel dimension; and
controlling, by the flow restrictor, a pressure of the slurry through the device, wherein an actuator is configured to control the flow restrictor to a first position from a second position and from the second position to the first position,
wherein the slurry passes through the valve body upon exiting the device.

18. The method of claim 17, wherein when the flow restrictor is in the first position the flow restrictor is engaged with the seat, and wherein in the second position the flow restrictor is removed from the seat.

19. The method of claim 17, further comprising:
setting the first position of the flow restrictor; and
setting the second position of the flow restrictor, wherein the second position of the flow restrictor is configured to allow more feedstock to flow through the flow channel than the first position of the flow restrictor.

20. The method of claim 17, further comprising measuring, by a position controller, a travel range of the flow restrictor from the first position to the second position.

21. The method of claim 20, further comprising determining, by the position controller, the integrity of the seat and the flow restrictor based on the travel range.

22. The method of claim 17, wherein the slurry includes at least a portion of water, and wherein the water flashes to steam as it flows through the valve body.

23. The method of claim 22, wherein the slurry comprises between 40% and 85% water.

24. The method of claim 17, further comprising introducing a pressure drop to the slurry as the slurry passes through the valve body.

25. The method of claim 17, further comprising clearing, by the flow restrictor, the slurry in the flow channel, wherein the step of clearing the slurry includes moving the flow restrictor between the first position and the second position in rapid succession.

26. The method of claim 17, wherein the flow of slurry exiting the device is substantially restricted when the flow restrictor is in the close position.
